(19) United States
(12) Patent Application Publication
(10) Pub. No.: US 2026/0324829 A1
(43) Pub. Date: Oct. 22, 2026

(54) HEATER ASSEMBLY

(71) Applicant: Dyson Technology Limited, Malmesbury, Wiltshire (GB)

(72) Inventors: Mouna HAMDIS, Swindon (GB); Samuel Stuart CLARKE, Bristol (GB); Chaoying FANG, Tetbury (GB); Alexander Stuart LAMOURY, Bristol (GB); Henry Oliver Tate MILLS, Bristol (GB); Paul Ian CHANDLER, Warwick (GB)

(21) Appl. No.: 19/107,754

(22) PCT Filed: Aug. 30, 2023
(86) PCT No.: PCT/IB2023/058551

§ 371 Date: Feb. 28, 2025

(30) Foreign Application Priority Data
Aug. 31, 2022 (GB) 2212581.9

(51) Int. Cl. A45D 2/00; H05B 1/02

(52) U.S. Cl. CPC A45D 2/001; H05B 1/0252; H05B 2203/005; H05B 2203/013

(57) ABSTRACT

A heater assembly for a haircare appliance is described. The heater assembly includes a contact member defining a hair-contacting surface. The contact member includes a heat spreading layer. The heater assembly has one or more heating elements for heating the contact member. The heat spreading layer can have a lateral thermal resistance of no greater than 22 Kelvin/Watt.

### TECHNICAL FIELD

The present invention relates to a heater assembly for a haircare appliance, and to a haircare appliance included the heater assembly.

### BACKGROUND

A haircare appliance may utilise a pair of heated clamping plates to style the hair of a user. In use, a tress of hair is clamped between the heated clamping plates, and the haircare appliance is drawn along the length of the tress. This process may then be repeated to style a full head of hair.

In known arrangements, each clamping plate may have a thickness of around 2-3 mm, and may be formed from e.g. stainless steel, aluminium, copper or brass. Clamping plates having a thickness of this order are relatively stiff, and do not have the flexibility to achieve a corralling effect, where hair is gathered and shaped. Furthermore, thicker clamping plates have a slower thermal response than thinner clamping plates, which means that in general the temperature of thicker clamping plates cannot be adjusted as quickly as for thinner clamping plates. Thus, the use of thicker clamping plates may result in a less controllable and flexible haircare appliance.

However, reducing the thickness of clamping plates much below the above-noted value of 2-3 mm can be problematic, as doing so can cause the clamping plates to suffer from a non-uniform temperature distribution across their surfaces when heated for use. This may result in high temperature hot-spots that can burn and damage hair clamped between the plates, and potentially even the plates themselves which in some cases may suffer permanent deformation.

It is an object of the present invention to provide an improved heater assembly for a haircare appliance.

### SUMMARY

In a first aspect the invention provides a heater assembly for a haircare appliance. The heater assembly comprises a contact member that defines a hair-contacting surface, wherein the contact member comprises a heat spreading layer. The heater assembly comprises one or more heating elements for heating the contact member. The heat spreading layer has a lateral thermal resistance of no greater than 22 Kelvin/Watt.

Utilising a heat spreading layer having a lateral thermal resistance of no greater than 22 Kelvin/Watt in the haircare appliance advantageously improves the distribution of heat across the hair-contacting surface, thereby reducing the likelihood of hot-spots forming across the hair-contacting surface. In this way, the risk of damage to hair caused by excessive heating is reduced. Furthermore, safety of a haircare appliance including the heater assembly is improved.

The heat spreading layer may have a thickness of no greater than 500 μm. The heat spreading layer may have a thickness of no greater than 200 μm. A thinner heat spreading layer is preferable for better flexibility of the heat spreading layer, and of the heater assembly. Better flexibility is advantageous to enable corralling, where hair is gathered and shaped, to be achieved with a haircare appliance including the heater assembly. Thus, the heating assembly advantageously provides for improved styling capability of a haircare appliance.

The heat spreading layer may be formed of a stainless steel and copper trimetallic material, copper or pyrolytic graphite. These materials advantageously have material parameters, i.e. thermal conductivities, that enable a lateral thermal resistance of no greater than 22 Kelvin/Watt to be achieved using a relatively small thickness of heat spreading layer for a given arrangement. This allows the desired heat spreading effect to be achieved using a relatively thin and flexible element that enables corralling.

The contact member may comprise a stainless steel plate. The heat spreading layer may be provided on a surface of the stainless steel plate. In some examples, the heat spreading layer may be provided on an outer surface of the stainless steel plate to define the hair-contacting surface. In other examples, the heat spreading layer may be provided on an inner surface of the stainless steel plate. Furthermore the heat spreading layer may be provided remote from the stainless steel plate, at any suitable position in the heater assembly.

At least one of the heating elements may comprise a thin-film heater. The heating elements may together cover an area of no less than 50% of the hair-contacting surface of the contact member. The heating elements may together extend across no less than 95% of a length of the hair-contacting surface of the contact member. This coverage of the heating elements across the hair-contacting surface is advantageous as it assists in providing a more uniform heat distribution across the hair-contacting surface.

The heater assembly may have a heat capacity per unit area of less than 0.004 J.K⁻¹.mm⁻². A relatively low heat capacity (i.e. low thermal mass) may be beneficial, as it allows the heater assembly to be more responsive to heating demands. For example, the heater assembly may be more quickly heated to an operating temperature, and/or respond more quickly to temperature changes during use, e.g. as hair is brought into contact with and then subsequently removed from the heater assembly.

The heater assembly may comprise multiple heating elements to define a multiple element heater assembly.

The heating elements together may draw no more than 500 W from a power supply for heating of the contact member. In other words, the total maximum power supplied to the heating elements may be 500 W, such that the heating elements together have an upper power limit of 500 W. In this way, the maximum heat energy supplied to the heater assembly is limited to prevent hot spots forming at any position within or on the heater assembly. Limiting the maximum power supplied to the heating elements limits the heat energy supplied by the heating elements, and thus limits the heat energy that reaches the contact member of the heater assembly. This ensures that the contact member is capable of effectively dissipating the heat received from the heating elements so to avoid hot spots on or in the contact member.

In a second aspect the invention provides a haircare appliance comprising a heater assembly according to any preceding paragraph. The haircare appliance may comprise a controller configured to control the power supplied to each of the heating elements. Specifically, the controller may be configured to independently control the power supplied to each of the heating elements. This enables the temperature of each heating element to be controlled independently, and provides for a more controllable and flexible styling process.

The heater assembly may comprise at least one electrical insulation layer positioned between the heating elements and the contact member. In this way, the contact member is electrically isolated from the heating element or elements, and safety of the device is improved.

The heater assembly may comprise one or more sensors for sensing a temperature at one or more positions of the contact member, and in particular at one or more positioned of the hair-contacting surface. The controller may be configured to control the power supplied to each of the heating elements in dependence on the temperatures indicated by the one or more sensors. In this way, the amount of heat produced by each heating element can be independently controlled based on the temperature of a region of hair-contacting surface associated with the heating element. This allows for better control of the temperature across the hair-contacting surface of the heater assembly, and thus improved styling capability of the device.

### BRIEF DESCRIPTION OF THE DRAWINGS

FIG. 1 is a side view of a haircare appliance with arms of the haircare appliance in an open position;

FIG. 2 is a perspective view of the haircare appliance of FIG. 1 with the arms in a closed position;

FIG. 3 is a partially exploded view of the haircare appliance of FIG. 1;

FIG. 4 is an exploded view of part of a heating section of the haircare appliance of FIG. 1;

FIG. 5 is an exploded view of a heater assembly of the haircare appliance of FIG. 1;

FIG. 6 is a cross-sectional view showing the heater assembly of FIG. 5;

FIG. 7 is a perspective view of a heat spreading layer of the heater assembly of FIG. 5;

FIG. 8 is a plan view of an alternative example of a sensor and heating element layer of a heater assembly; and

FIG. 9 is a plan view of another alternative example of a sensor and heating element layer of a heater assembly.

### DETAILED DESCRIPTION

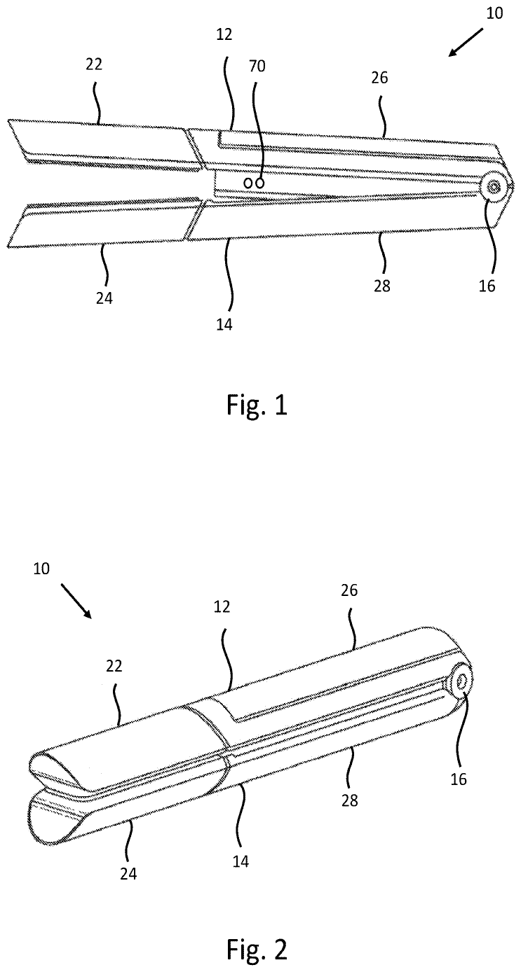

The haircare appliance 10 of FIGS. 1 and 2 comprises a first arm 12 and a second arm 14 pivotably connected at one end by a hinge 16. The arms 12,14 are moveable about the hinge 16 between an open position (shown in FIG. 1) and a closed position (shown in FIG. 2). The haircare appliance 10 may take the general form of a hair straightener.

Each arm 12,14 comprises a heating section 22,24 located at an end of each arm 12,14 remote from the hinge 16, and a handle section 26,28 located at an opposite end of each arm 12,14 where the hinge 16 is positioned. In use, the user grips the handle sections 26,28 and inserts a section or tress of hair between the two arms 12,14. The user applies pressure to the handle sections 26,28 to close the arms 12,14 and grip the hair between the heating sections 22, 24, and pulls the haircare appliance 10 along the length of the hair to be styled. The arms 12,14 are biased towards the open position such that when the user releases the pressure on the handle sections 26,28, the arms 12,14 return to the open position and the tress of hair is released.

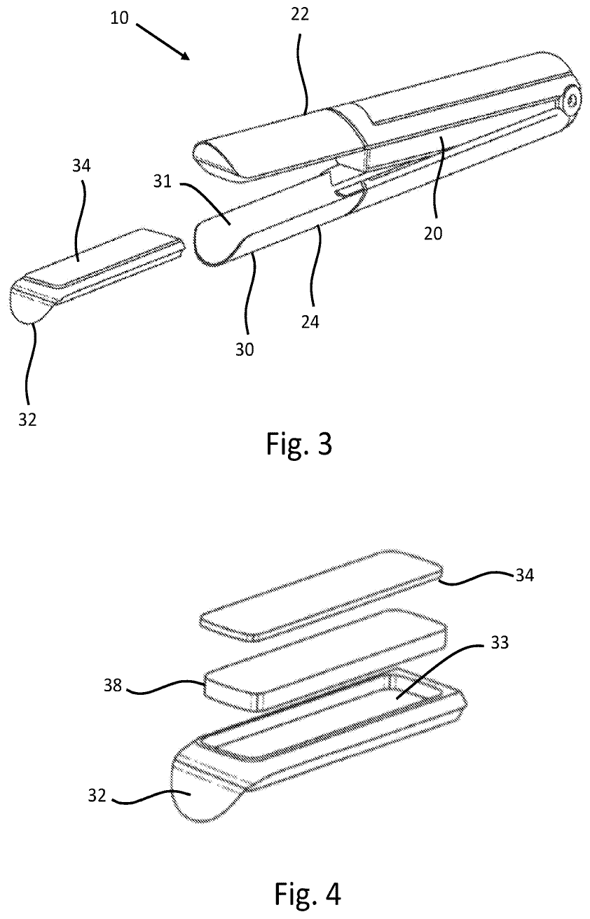

Referring now to FIGS. 3 and 4, the heating section 22,24 of each arm 12,14 comprises a casing 30, a heater assembly housing 32, a heater assembly 34 and a support member 38. The casing 30 defines a trough 31 within which the heater assembly housing 32 is located. The heater assembly housing 32 comprises a recess 33 within which the support member 38 and the heater assembly 34 are located. The support member 38 is located between the heater assembly housing 32 and the heater assembly 34 and supports the heater assembly 34 within the heater assembly housing 32. The heater assembly 34 is located on top of the support member 38. That is, the heater assembly 34 is located on the side of the support member 38 that is distal from the heater assembly housing 32.

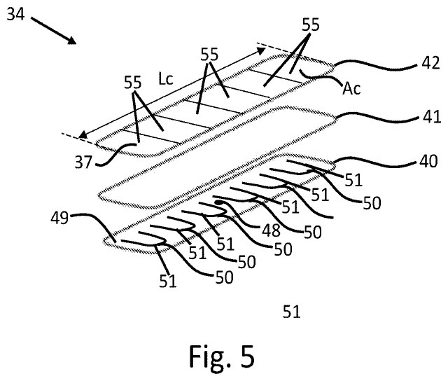

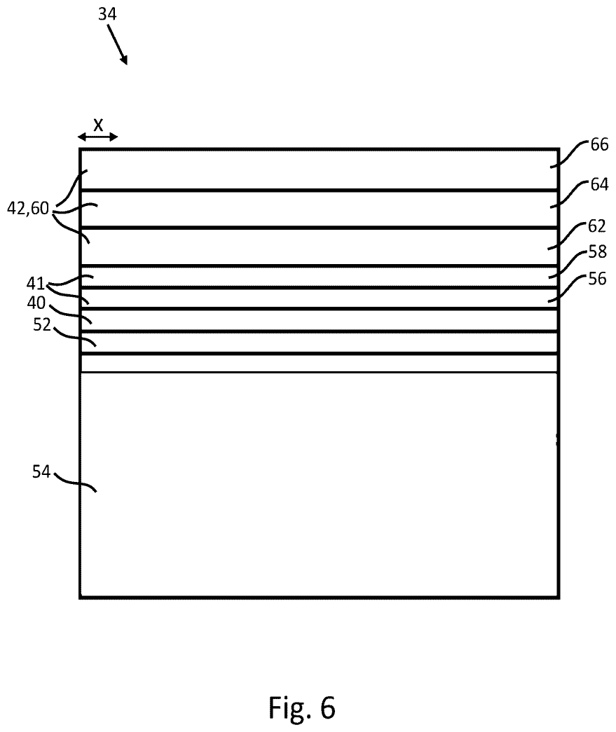

The heater assembly 34 will now be described with reference to FIGS. 5 and 6 in particular.

The heater assembly 34 comprises multiple layers of components arranged in a stack. Specifically, the heater assembly 34 comprises a sensor and heating element layer 40, an electrical insulation layer 41, and a contact member 42 that defines a hair-contacting surface 37 of the haircare appliance 10 for contacting and styling hair in use.

The heater assembly 34 preferably has a relatively low heat capacity per unit area of the hair-contacting surface 37 of no more than 0.004 J.K⁻¹.mm⁻². A lower heat capacity per unit area is preferable because as this value increases, the thermal responsiveness of the heater assembly 34 decreases. As such, a heater assembly 34 having a lower heat capacity per unit area allows for faster heating and cooling of the contact member 42 and of the hair-contacting surface 37, which enables better control of the temperature of the hair contacting surface 37 for improved hair styling and safety of the haircare appliance 10.

In the orientation of the heater assembly 34 shown in FIGS. 5 and 6, the sensor and heating element layer 40 is located beneath the electrical insulation layer 41. In this way, the sensor and heating element layer 40 defines an inner layer of the heater assembly 34 that is remote from the hair-contacting surface 37. In this example the electrical insulation layer 41 is positioned above a dielectric cover 52 that is overmoulded with a flexible backing of silicone 54 (shown in FIG. 6) that allows for corralling of the contact member 42 and hair-contacting surface 37.

The sensor and heating element layer 40 has a thickness of 0.05 mm in this example, but in other examples the thickness of the sensor and heating element layer 40 may vary. However, in general a thinner sensor and heating element layer 40 is preferable for increased flexibility.

The sensor and heating element layer 40 comprises a substrate 49, multiple heating elements 50 and a sensor 48. The substrate 49 supports and locates the sensor 48 and the heating elements 50 within the heater assembly 34, and further provides electrical insulation to insulate the heating elements 50 from one another and from the sensor 48. In this example, the substrate 49 has the same shape and area as the electrical insulation layer 41 and contact member 42, and comprises a layer of glass based dielectric material that supports the sensor 48 and heating elements 50. However, other materials such as pre-preg, which is a partially cured fibre resin composite sheet material that can be used for electrical insulation and bonding, or polyimide may be used. Moreover, in other examples, the substrate 49 may comprise more than one layer or sheet on or between which the sensor 48 and heating elements 50 are located. Furthermore, it would be possible for the sensor 48 and heating elements 50 to be provided on different layers from one another, so as to define a distinct sensor layer and a distinct heating element layer. In that case, the sensor layer and the heating element layer may be separated by a layer of insulation. It should be noted that in other examples additional sensors 48 may be included, such that the sensor and heating element layer 40 may generally include one or more sensors 48. In some cases the sensor and heating element layer 40 may include equal numbers of sensors 48 and heating elements 50, such that each heating element 50 has an associated sensor 48. In examples where the sensor and heating element layer 40 includes multiple sensors 48, said sensors may be equally spaced along the length of the sensor and heating element layer 40.

The heating elements 50 provide heat to the contact member 42, which in turn provides heat to hair in contact with a hair-contacting surface 37 of the contact member 42 in use. In this example, the sensor and heating element layer 40 includes six heating elements 50 that each comprise a resistive track 51 and a pair of conductive pads (not shown). The resistive track 51 of each heating element 50 comprises a material such as copper, silver, constantan or stainless steel, and extends over the substrate 49 to define a generally U-shaped resistive track 51, with the conductive pads located at either end of the resistive track 51. The resistive tracks 51 may be formed by processes such as etching or printing. However, in other examples, one or more of the heating elements 50 may be formed from a length of wire. Furthermore, the sensor and heating element layer 40 may comprise more or fewer heating elements 50 in other examples.

In this example, the heating elements 50 take the form of thick film printed heater traces, but other forms of heating element may be used, such as foil heaters, thin-film heaters, tubular heating elements, etched heaters or coiled heating elements.

The heating elements 50 together extend over the substrate 49 such that the heating elements 50 together cover about 25% of an area, Ac, defined by the hair-contacting surface 37 of the contact member 42, and span about 80% of a length, Lc, defined by the hair-contacting surface 37 of the contact member 42. In other examples these percentage values may vary, and in fact the heating elements 50 together may preferably cover no less than 50% of the area, Ac, defined by the hair-contacting surface 37 and span no less than 95% of the length, Lc, defined by the hair-contacting surface 37. In this way, a more even distribution of heat across the contact member 42 and hair-contacting surface 37 is provided.

Each of the resistive tracks 51 is located beneath a different heating zone 55 of the contact member 42 such that each heating element 50 heats a respective heating zone 55 of the contact member 42 and thus of the hair-contacting surface 37. Thus, in this example of FIG. 5 having six heating elements 50 equally spaced along the length Lc of the contact member 42, the contact member 42 is divided into six heating zones 55 of equal length, and the heater assembly 34 is a six zone heater. In use, the power supplied to each heating element 50 may be controlled independently. Specifically, the haircare appliance 10 may comprise a controller (not shown) configured to independently control the power supplied to each of the heating elements 50, such that different amounts of power may be supplied to each heating element 50. This allows for more precise control of the temperature of the hair-contacting surface 37 to be achieved.

The sensor 48 senses or measures a temperature of the heater assembly 34, and provides an indication of the a temperature of the hair-contacting surface 37 of the contact member 42. That is, although the sensor 48 does not directly measure the temperature of the hair-contacting surface 37 in this example, the temperature sensed or measured by the sensor 48 provides a good approximation of the temperature at the hair-contacting surface 37.

In this example, the sensor 48 comprises a thermistor connected to a pair of wires, but in other examples the sensor 48 may take a different form, for example a thermocouple. In some examples the sensor 48 may be a printed film sensor.

As shown in FIG. 5, the sensor 48 is located between (and spaced from) parallel portions of the resistive track 51 of neighbouring heating elements 50 on a central portion of the substrate 49, so as to be located centrally along a length, Lc, defined by the hair-contacting surface 37 of the contact member 42. As a result, the sensor 48 is arranged to sense the temperature of the hair-contacting surface 37 at a position centrally along its length, Lc. However, in other examples the sensor 48 may be provided at a different position on the substrate 49, so as to sense the temperature at a different position on the hair-contacting surface 37. Furthermore, the sensor and heating element layer 40 may comprise multiple sensors 48 provided at different locations on the substrate 49 to allow for multiple temperature measurements to be taken, at different locations on the hair-contacting surface 37. In examples in which the sensor and heating element layer 40 includes multiple sensors 48, these sensors 48 may be positioned across the sensor and heating element layer 40 so as to be equally spaced from one another. This arrangement advantageously allows the temperature of the hair-contacting surface 37 to be measured at multiple positions across the length of the contact member 42. This temperature information can be used to determine whether the heat supplied to the contact member 42 from one or more of the heating elements 50 should be adjusted. For example, if one of the sensors 48 measures a temperature that is below the desired temperature of the hair-contacting surface 37, the power supplied to an associated heating element 50 may be adjusted to supply more heat to its associated heating zone 55, so as to raise the temperature of its associated heating zone 55 accordingly. As noted already, the sensor or sensors 48 may be provided on a separate layer to the heating elements 50.

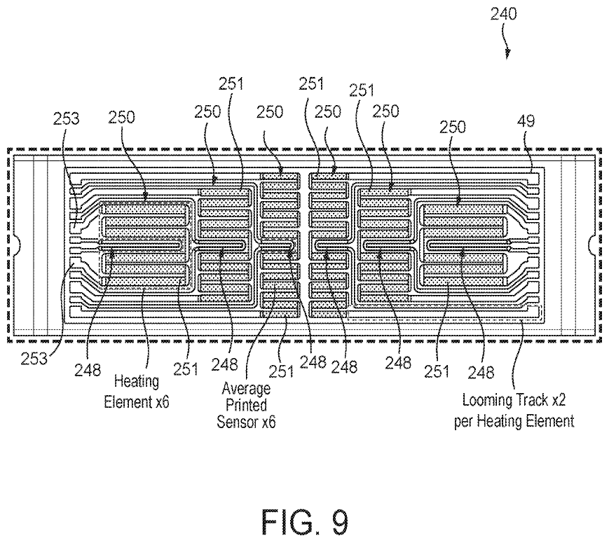

FIGS. 8 and 9 show alternative examples of sensor and heating element layers 140 and 240 that may be utilised in the haircare appliance 10. In these examples, the sensor and heating element layers 140, 240 comprise a plurality of heating elements 150, 250 and a plurality of sensors 148, 248, each of the sensors 148, 248 being associated with one of the heating elements 150, 250, respectively.

The sensor and heating element layer 140 of FIG. 8 comprises three heating elements 150 and three associated sensors 148. Each heating element 150 comprises a resistive track 151 in a concentric rectangular shape and a pair of conductive pads 153 for supplying power to each of the resistive tracks 151 independently. As in the example of FIG. 5, each of the resistive tracks 151 is located beneath a different zone of the contact member 42 such that each of heating elements 150 heats a respective zone of the contact member 42 and thus the hair-contacting surface 37. As in the example of FIG. 5, in use the power supplied to each of the heating elements 150 may be controlled independently to allow for more precise control of the temperature of the hair-contacting surface 37 to be achieved.

The sensor and heating element layer 240 of FIG. 9 comprises six heating elements 250 and six associated sensors 248 each provided generally centrally with respect to their associated heating element 250. Each heating element 250 comprises a resistive track 251 that extends in a serpentine shape over the substrate 49 and a pair of conductive pads 253 (only two of which are labelled in FIG. 9 for clarity) for supplying power to each of the resistive tracks 251 independently.

In the example of FIG. 9, the resistive track 251 of each heating element 250 has a thickness of around 0.015 mm, a width of around 1.0 mm and a spacing between adjacent parallel portions of the track 251 of around 0.5 mm. Where parallel portions of the track 251 are separated by the associated sensor 248, the spacing between the portions of track 251 at each side of the sensor 248 is greater than 0.5 mm so as to accommodate the sensor 248. In other examples, different track thicknesses, widths and spacings may be used to achieve a desired coverage of the hair-contacting surface 37. Furthermore, in other examples the track thicknesses, widths and spacings may differ between different heating elements 50.

As in the examples of FIGS. 5 and 8, each resistive track 251 is located beneath a different zone of the contact member 42 such that each heating element 250 heats a respective zone of the contact member 42 and thus of the hair-contacting surface 37. As in the examples of FIGS. 5 and 8, in use the power supplied to each of the heating elements 250 may be controlled independently to allow for more precise control of the temperature of the hair-contacting surface 37 to be achieved.

The multiple sensors 148 and 248 of the examples of FIGS. 8 and 9 respectively allow the temperature of each of the zones of the hair-contacting surface 37 to be determined. This enables the temperature of the hair-contacting surface 37 to be better controlled for improved styling results. Furthermore, controlling the temperature of different zones of the hair-contacting surface 37 assists in avoiding overheating of the hair-contacting surface 37, thereby reducing the likelihood of damage to hair in contact with the hair-contacting surface 37 in use.

Now turning back to FIG. 6, the electrical insulation layer 41 of the heater assembly 34 comprises a first layer 56 and a second layer 58. The electrical insulation layer 41 is provided between the sensor and heating element layer 40 and the contact member 42, so as to electrically isolate the contact member 42 from the heating element 50 (not shown in FIG. 6) of the sensor and heating element layer 40 for safety. With the heater assembly 34 orientated as shown in FIGS. 5 and 6, the first layer 56 is positioned directly above the sensor and heating element layer 40, and the second layer 58 is positioned directly above the first layer 56 and directly beneath the contact member 42. In this example, the first layer 56 and the second layer 58 are each formed of a glass based dielectric material, and each have a thickness of 0.0175 mm. However, it will be understood that other materials and thicknesses of the electrical insulation layer 41 and any constituent layers of the electrical insulation layer 41 are possible to electrically isolate the contact member 42 from the heating element 50. For example, in some cases materials such as pre-preg or polyimide may be utilised in the electrical insulation layer 41.

Both the thickness of the electrical insulation layer 41 and the material(s) of the electrical insulation layer 41 affects the thermal resistance of the electrical insulation layer 41. In general, for a given material, a thicker electrical insulation layer 41 has a higher thermal resistance. An electrical insulation layer 41 having a higher thermal resistance is more resistant to the transfer of heat across it. Thus, a thicker electrical insulation layer 41 may reduce the amount of heat that reaches the contact member 41 and hair-contacting surface 37. The thickness and material(s) of the electrical insulation layer 41 are chosen with this in mind.

The contact member 42 is provided on top of the electrical insulation layer 41, so as to be positioned above the electrical insulation layer 41 in the orientation shown in FIG. 5. In this way, the hair-contacting surface 37 defines an outer surface of the heater assembly 34 and is arranged to contact and heat hair received between the arms 12,14 of the haircare appliance 10 for styling in use.

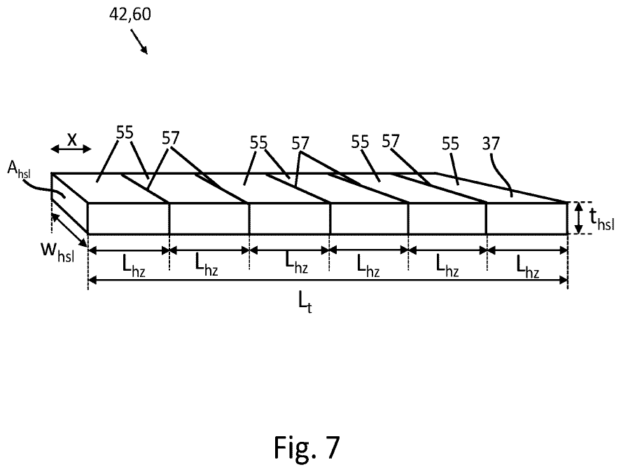

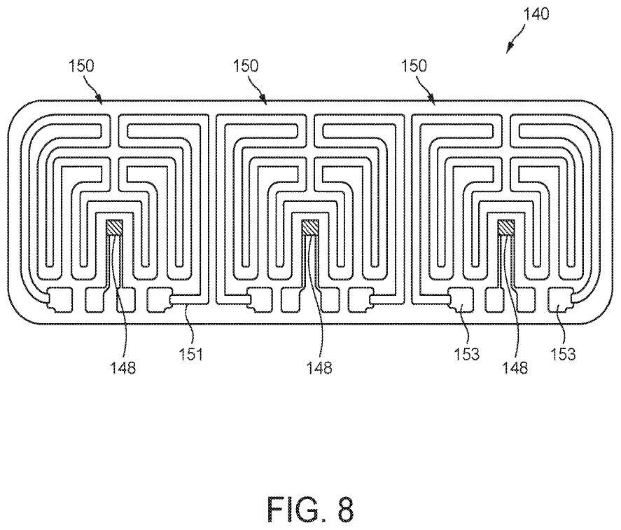

The contact member 42 comprises a heat spreading layer 60, represented in isolation in FIG. 7. In this example the contact member 42 is defined in its entirety by the heat spreading layer 60, but in other examples the heat spreading layer 60 may form only a part of the contact member 42. As shown in FIG. 7, the heat spreading layer 60 comprises six heating zones 55 of equal length, L_{hz}. As explained already, each heating zone 55 is associated with a corresponding heating element 50 located beneath that heating zone 55. It should be noted that boundary lines 57 between the heating zones 55 are shown on the heat spreading layer 60 for illustrative purposes only, and do not indicate distinct segments of the heat spreading layer 60 which in this case is defined by a continuous layer of material.

The heat spreading layer 60 is arranged and configured to spread heat provided by the heating element 50 of the sensor and heating element layer 40 through the contact member 42 and across the hair-contacting surface 37 of the contact member 42, so as to provide a more uniform temperature distribution across the hair-contacting surface 37. The heat spreading layer 60 is configured in particular to provide a more uniform distribution of heat from the sensor and heating element layer 40 across the length, Lc, of the hair-contacting surface 37.

Achieving a more uniform temperature distribution across the length, Lc, of the hair-contacting surface 37 is advantageous as this allows for hair engaged at different locations along the length, Lc, of the hair-contacting surface 37 to be styled more consistently as the haircare appliance 10 is pulled along the length of the hair in use. Furthermore, improving temperature uniformity across the hair-contacting surface 37 advantageously reduces the temperature of any hot-spots that may develop across the hair-contacting surface 37 in use. This reduces the likelihood of damage to hair caused by excessive temperature in hot-spot regions of the hair-contacting surface 37, and improves the safety of the haircare appliance 10.

To achieve a more uniform temperature distribution across the hair-contacting surface 37, the heat spreading layer 60 has a lateral thermal resistance, R, of no greater than 22 Kelvin/Watt.

The thermal resistance of a material is a measure of how resistant the material is to the transfer of heat across it. The lateral thermal resistance of the heat spreading layer, Rₕₛₗ, is the thermal resistance experienced by heat propagating through the heat spreading layer in a lateral direction, x, and is defined as:

Rₕₛₗ=Lₕₛₗ/(kₕₛₗ*Aₕₛₗ) Equation 1

In equation 1, Lₕₛₗ is the length travelled by heat from the heating elements 50 in the heat spreading layer 60 in the lateral direction, x, and is defined as half the length L_{hz} of a heating zone 55, i.e. Lₕₛₗ=L_{hz}/2. With this definition in mind, it will be understood that the length, Lₕₛₗ, is dependent on the total length of the heat spreading layer, Lt, and the number of heating elements 50 and corresponding heating zones 55.

Aₕₛₗ is a cross-sectional area of the heat spreading layer, and kₕₛₗ is the thermal conductivity of the heat spreading layer. In the example of FIG. 7 in which the heat spreading layer 60 has a rectangular cross-section, the cross-sectional area, Aₕₛₗ, is defined as the thickness of the heat spreading later, tₕₛₗ, multiplied by the width of the heat spreading layer, wₕₛₗ, i.e. Aₕₛₗ=wₕₛₗ*tₕₛₗ. However, the specific definition of the cross-sectional area, Aₕₛₗ, will of course vary depending on the shape of the cross-sectional area, which is not limited to square or rectangular.

It will be understood from Equation 1 that for a given number of heating elements 50 and associated heating zones 55, and a given-length, Lt, and width, wₕₛₗ, of the heat spreading layer 60, a material having an appropriate thermal conductivity and thickness can be chosen to provide a lateral thermal resistance of no more than 22 Kelvin/Watt.

However, if the heat spreading layer 60 is too thick, the flexibility of the heat spreading layer 60 is reduced, which in turn reduces the flexibility of the contact member 42 and the ability of the haircare appliance 10 to achieve corralling, where the hair is gathered and shaped between the arms 12,14 in use. Furthermore, a thicker heat spreading layer 60 results in a slower thermal response of the contact member 42, and thus slower heating and cooling of the contact member 42 in response to changes in the heat provided from the sensor and heating element layer 40.

Thus, a thinner heat spreading layer 60 may be preferable to provide better flexibility of the contact member 42 for corralling, and to deliver adaptive hair styling modes such as a ‘root-to-tip’ mode in which the temperature of the hair-contacting surface 37 is dynamically varied as the haircare appliance 10 is pulled from the root of the hair to the tip of the hair. Specifically, the thickness of the heat spreading layer 60 is preferably no greater than 0.500 mm, and more preferably no greater than 0.200 mm.

Referring now again to FIG. 6, in this example the heat spreading layer 60 defines the contact member 42 in its entirety, and itself comprises a lower layer 62, a middle layer 64 and an upper layer 66. The lower layer 62, middle layer 64 and upper layer 66 are joined together so as to define a single self-supporting layer, i.e. the heat spreading layer 60. The lower layer 62 and the upper layer 66 are each formed of stainless steel and the middle layer 64 is formed of copper, such that the heat spreading layer 60 is defined by a stainless steel and copper trimetallic material, which is a sandwich of stainless steel, copper and stainless steel, in this example. The thermal conductivity, kₕₛₗ, of the stainless steel and copper trimetallic material of this example is 180 W/mK. The lower layer 62, the middle layer 64 and the upper layer 66 each have a thickness of 0.0333 mm, such that the heat spreading layer 60 of this example has a total thickness, tₕₛₗ, of approximately 0.100 mm. Thus, in this example in which the total length of the heat spreading layer, Lt, is 90 mm, the width of the heat spreading layer, wₕₛₗ, is 25 mm, and the heat spreading layer 60 includes six heating zones 55 of equal length, the heat spreading layer has a lateral thermal resistance, Rₕₛₗ, of approximately 17 Kelvin/Watt.

As discussed above, the lateral thermal resistance, Rₕₛₗ, of the heat spreading layer 60 may differ in other examples, but must not exceed 22 Kelvin/Watt. Thus, the material and thickness, tₕₛₗ, of the heat spreading layer 60 may differ from that of the described example of FIG. 6, so long as the lateral thermal resistance, Rₕₛₗ, is no more than 22 Kelvin/Watt. For flexibility, the thickness, tₕₛₗ, of the heat spreading layer 60 preferably does not exceed 0.5 mm.

The total maximum power supplied to the heating elements 50 together does not exceed 500 W. This maximum power limit ensures that the heater assembly 34 is able to effectively manage and dissipate the heat from the heating elements 50 such that the temperature at any position on or within the heater assembly 34, including at the hair contacting surface 37, does not exceed a pre-determined upper temperature limit. In this example, the upper temperature limit is chosen to be 250 °C so as to avoid hot spots in the heater assembly 34 and on the hair contacting surface 37, which are considered to be present if any part of the heater assembly 34 exceeds a temperature of 250 °C.

In the specific example of FIG. 6, the total maximum power supplied to the heating elements 50 is approximately 228 W, and each heating element 50 draws a maximum power of approximately 38 W. The highest temperature at any location on the hair contacting surface 37 at this maximum power draw is around 240 °C. Thus, the temperature of the hair-contacting surface 37 does not exceed the upper temperature limit of 250 °C, thereby avoiding hot-spots on the hair-contacting surface 37.

It should be understood that the maximum power limit may differ depending, for example, on the material, thickness and configuration of the heat spreading layer 60.

Turning now to other examples the heat spreading layer 60 may be formed entirely of copper or entirely of pyrolytic graphite. Thus, rather than being defined by a composite layer as in the example of FIG. 6, the heat spreading layer 60 may be formed as a single layer.

In specific examples the heat spreading layer 60 may be formed entirely of copper and have a thickness, tₕₛₗ, of 0.100 mm and a lateral thermal resistance, Rₕₛₗ, of 7.7 Kelvin/Watt. In other specific examples the heat spreading layer 60 may be formed entirely of copper and have a thickness, tₕₛₗ, of 0.400 mm and a lateral thermal resistance, Rₕₛₗ, of 1.9 Kelvin/Watt.

In specific examples the heat spreading layer 60 may be defined entirely by a pyrolytic graphite sheet that is glued or otherwise bonded beneath a plate of the contact member 42. In these cases, the heat spreading layer 60 does not contact the hair in use, and the plate defines the hair-contacting surface 37 of the contact member 42. The plate of the contact member 42 may be formed, for example, of stainless steel, and the heat spreading layer 60 may have a thickness, tₕₛₗ, of 0.100 mm and a lateral thermal resistance, Rₕₛₗ, of 4.3 Kelvin/Watt. In other specific examples the heat spreading layer 60 defined by a pyrolytic graphite sheet may have a thickness, tₕₛₗ, of 0.017 mm and a lateral thermal resistance, Rₕₛₗ, of 10 Kelvin/Watt.

It will be understood that other thicknesses of copper and pyrolytic graphite to those mentioned above are possible for the heat spreading layer 60, so long as the associated lateral thermal resistance, Rₕₛₗ, does not exceed 22 Kelvin/Watt.

It should be noted that although the heat spreading layer 60 entirely defines the contact member 42 in the example of FIG. 6, in other examples the heat spreading layer 60 may form only a part of the contact member 42, as in the above-noted example of pyrolytic graphite bonded beneath a plate of the contact member 42. In these cases, the heat spreading layer 60 may be provided at any position between the hair-contacting surface 37 and the sensor and heating element layer 40. For example, the contact member 42 may comprise a stainless steel plate that defines the hair-contacting surface 37, and the heat spreading layer 60 may be provided directly beneath the stainless steel plate, such that the heat spreading layer 60 is provided on an inner surface of the stainless steel plate opposite the hair-contacting surface 37. In other examples the heat spreading layer 60 may be provided beneath the electrical insulation layer 41, or in cases such as that of FIG. 6 in which the electrical insulation layer 41 is defined by multiple layers 56,58, the heat spreading layer 60 may be positioned between layers of the electrical insulation layer 41.

As explained already, the heat spreading layer 60 advantageously improves the distribution of heat across the hair-contacting surface 37, thereby reducing the likelihood of hot-spots forming across the hair-contacting surface 37, which in turn reduces the risk of damage to hair caused by excessive heat as well as improving safety of the haircare appliance 10. This is achieved by utilising a material or combination of materials having a suitable thermal conductivity for the heat spreading layer 60, and choosing an appropriate thickness of the heat spreading layer 60, so as to provide a lateral thermal resistance, Rₕₛₗ, of no more than 22 Kelvin/Watt for the given length, Lₜ, and width, wₕₛₗ of the heat spreading layer 60, and a given number of heating zones 55.

In known arrangements that utilise plates formed, for example, of stainless steel, aluminium, copper or brass for the contact members, a relatively uniform distribution of heat is achieved through use of relatively thick plates, generally having a thickness on the order of 2-3 mm. However, such relatively thick plates are generally not flexible enough to provide a corralling effect, and so cannot provide the functionality and styling capabilities of a haircare appliance 10 having thinner contact members.

The invention advantageously enables a uniform heat distribution to be achieved across the hair-contacting surface 37, without the use of a thick contact member plate that prevents flexibility and reduces the styling capability of the haircare appliance 10.

Whilst particular examples and embodiments have thus far been described, it should be understood that these are illustrative only and that various modifications may be made without departing from the scope of the invention as defined by the claims.

1. A heater assembly for a haircare appliance, the heater assembly comprising:
a contact member that defines a hair-contacting surface, wherein the contact member comprises a heat spreading layer; and
one or more heating elements for heating the contact member;
wherein the heat spreading layer has a lateral thermal resistance of no greater than 22 Kelvin/Watt.

2. A heater assembly according to claim 1, wherein the heat spreading layer has a thickness of no greater than 500 μm.

3. A heater assembly according to claim 2, wherein the heat spreading layer has a thickness of no greater than 200 μm.

4. A heater assembly according to claim 1, wherein the heat spreading layer is formed of a stainless steel and copper trimetallic material, copper or pyrolytic graphite.

5. A heater assembly according to claim 1, wherein the contact member comprises a stainless steel plate, and wherein the heat spreading layer is provided on a surface of the stainless steel plate.

6. A heater assembly according to claim 1, wherein at least one of the heating elements comprises a thin-film heater.

7. A heater assembly according to claim 1, wherein the heating elements together cover an area of no less than 50% of the hair-contacting surface of the contact member.

8. A heater assembly according to any preceding claim 1, wherein the heating elements together extend across no less than 95% of a length of the hair-contacting surface of the contact member.

9. A heater assembly according to claim 1, wherein the heater assembly has a heat capacity per unit area of less than 0.004 J.K⁻¹.mm⁻².

10. A heater assembly according to claim 1, comprising multiple heating elements.

11. A heater assembly according to claim 1, wherein the heating elements together draw no more than 500 W of power from a power supply for heating the contact member.

12. A haircare appliance comprising a heater assembly according to claim 1.

13. A haircare appliance according to claim 12, comprising a controller configured to control the power supplied to each of the heating elements.

14. A haircare appliance as claimed in claim 12, wherein the heater assembly comprises at least one electrical insulation layer positioned between the heating elements and the contact member.

15. A haircare appliance as claimed in claim 12, wherein the heater assembly comprises one or more sensors for indicating a temperature at one or more positions of the contact member.

16. A haircare appliance as claimed in claim 15, wherein the controller is configured to control the power supplied to each of the heating elements in dependence on the temperatures indicated by the one or more sensors.
